(19) United States
(12) Patent Application Publication
(10) Pub. No.: US 2004/0126040 A1
(43) Pub. Date: Jul. 1, 2004

(54) Fluid dynamic bearing module

(76) Inventors: Wun-Chang Shih, Hsinchu (TW); Ching-Hsing Huang, Taipei (TW); Yu-Hsiu Chang, Changhua (TW); Kuang-Hsien Chang, Taipei (TW); Mei-Lin Lai, Taichung (TW)

Correspondence Address: BIRCH STEWART KOLASCH & BIRCH, PO BOX 747, FALLS CHURCH, VA, 22040-0747, US

(21) Appl. No.: 10/378,839

(22) Filed: Mar. 5, 2003

(30) Foreign Application Priority Data
Dec. 27, 2002 (TW) 091221383

(51) Int. Cl. F16C 32/06

(52) U.S. Cl. 384/100

(57) ABSTRACT

A fluid dynamic bearing module for cooling fans connects the fixed part and the rotating part of a cooling fan and provides lubrication and support when the rotating part rotates relative to the fixed part. In the design of the invention the fluid dynamic bearing is a module that utilizes a bearing seat, a wear-resistant element and an anti-lift element to make the bearing module leak-proof, lift-proof, wear-resistant and able to create a balance of the lubricant and air.

### FIELD OF THE INVENTION

The invention relates to a fluid dynamic bearing module for small cooling fans and particularly to a fluid dynamic bearing module that is lubricant leak-proof, spindle lift-proof, spindle wear-resistant and that creates balance of the lubricant and air.

### BACKGROUND OF THE INVENTION

A bearing is a rotary mechanical element for supporting, reducing friction and carrying loads, and is adopted for use on main shaft motors or the like. With the continuous advance of technology, components are becoming miniaturized and more higher precise. Thus the demand for greater bearing precision is also increasing. In general, the most commonly used precision bearing is the ball bearing. However, ball bearings still have disadvantages: too much noise, not enough rotating accuracy and too costly for miniaturization. They cannot fully meet miniaturization and precision requirements. In order to meet the aforesaid requirements and to further reduce rotational friction, the fluid dynamic bearing has been developed. The fluid dynamic bearing has greater precision, makes less noise and has a higher vibration resisting capability.

Fluid dynamic bearings can generally be grouped in two types: static fluid dynamic bearings and dynamic fluid dynamic bearings. The static bearing in normal conditions contains a fluid lubricant that is injected by external pressure. During rotation the fluid pressure lifts the spindle. If the spindle is deviated, the pressure on the deviated side is increased to return the spindle to the normal position. As the bearing contains a large amount of fluid lubricant in normal conditions, it is not suitable for small sized and high precision rotary mechanical elements. The fluid dynamic bearing has miniaturized grooves inside to hold the lubricant (with a small amount of lubricant in the miniaturized grooves). When the spindle rotates, the lubricant in the grooves is drawn to generate dynamic pressure and support the spindle in the center position.

The fluid dynamic bearing has the advantages of longer service life, less noise and greater vibration resistance, thus is widely used on small fans. As the fluid dynamic bearing is not lubricant leak-proof and spindle lift-proof, the fan must have a special design to provide the required functions. Japanese patent publication No. 2000-009090 discloses such a design. It has the following features:

1. Lubricant leak-proof design: The fluid dynamic bearing has a through hole profile. The leak-proof feature is coupled with the stator of the fan. It is not a modular design, thus fan manufacturers cannot enjoy the benefits of modularization.

2. Spindle lift-proof design: The present fluid dynamic bearings used in fans are not lift-proof. Thus fan manufacturers have to design a separate lift-proof feature to conform to this requirement.

3. Balance of the lubricant and air: The fluid dynamic bearing requires balance of the lubricant and air during assembly and operation. It may be included either in the design of the fan mechanism or the bearing. Nevertheless, this factor has to be taken into account in the design.

4. Spindle wear-resistant design: The fluid dynamic bearings adopted on conventional fans do not have a wear-resistant plate in the bearing. Fan manufacturers have to add this during assembly.

The foregoing patent or other techniques do not adopt a modular design for the fluid dynamic bearing of the cooling fans. They hinder the assembly convenience of the fans that use fluid dynamic bearings. Moreover, product quality is difficult to control and production cost of the cooling fans increases.

### SUMMARY OF THE INVENTION

In view of the aforesaid disadvantages, the primary object of the invention is to provide a modularized fluid dynamic bearing module to facilitate assembly and also to provide lubricant leak prevention, spindle lift prevention, balance of lubricant and air, and spindle wear-resisting functions.

The fluid dynamic bearing module of the invention consists of a fluid dynamic bearing, a bearing seat, a wearing-resisting element and an anti-lift element. The fluid dynamic bearing is hollow for holding the spindle of a rotating part and has an inner wall formed of a plurality of dynamic grooves filled with a lubricant such that when the spindle rotates relative to the fluid dynamic bearing, the lubricant in the dynamic grooves generates dynamic pressure to do supporting and lubricating. The bearing seat has a housing chamber with only one opening at one side to house the fluid dynamic bearing. The bearing seat has a bottom section for holding a wear-resistant element made from a wear-resistant material to be in contact with the spindle installed in the fluid dynamic bearing. The anti-lift element is installed on the opening side of the bearing seat and has a round opening with a radius slightly smaller than the spindle to latch on the spindle and prevent the spindle from separating.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1A is a sectional view of the fluid dynamic bearing module of the invention adopted for use on a small cooling fan.

FIG. 1B is a perspective view of the fluid dynamic bearing module of the invention adopted for use on a small cooling fan.

FIG. 2 is an exploded view of the fluid dynamic bearing module of the invention.

FIG. 3A is a sectional view of the fluid dynamic bearing module of the invention.

FIG. 3B is a perspective view of the fluid dynamic bearing module of the invention.

FIG. 4 is a sectional view of the fluid dynamic bearing module of the invention coupling with a spindle.

### DESCRIPTION OF THE PREFERRED EMBODIMENT

The object of the fluid dynamic bearing module disclosed in the invention is to output rotational kinetic energy on electric generators such as brushless DC motors, brushless DC fans, brushed DC motors, brushed DC fans, brushless AC motors, brushless AC fans, brushed AC motors, brushed AC fans, small cooling fans, or the like. The following embodiment is based on a small cooling fan. It only serves as an example, and should not be deemed as a limitation of the invention.

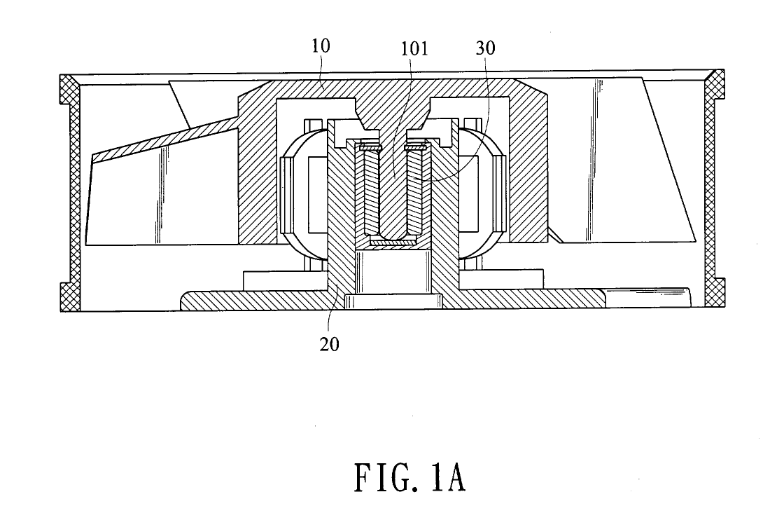

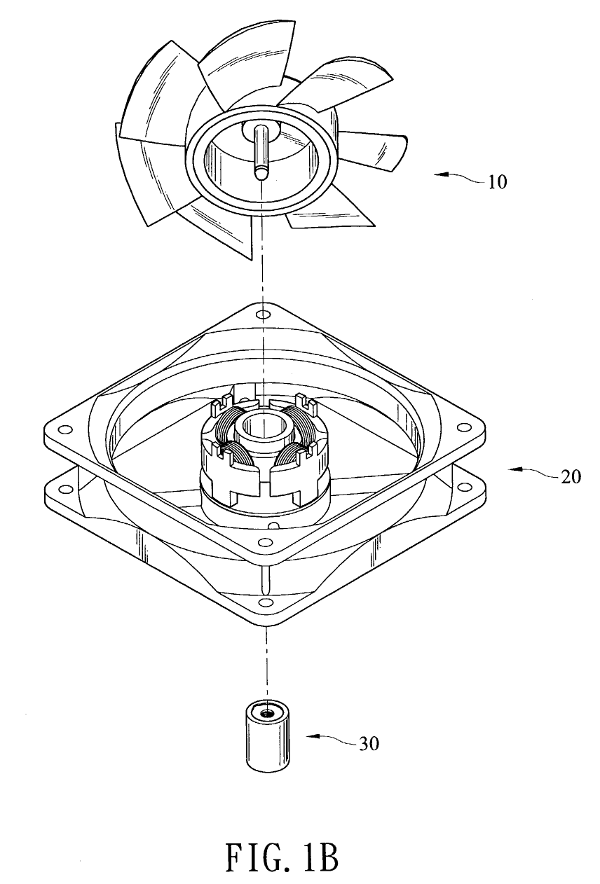

Referring to FIGS. 1A and 1B, the cooling fan consists of a rotating part 10, a fixed part 20 and a fluid dynamic bearing module 30. The rotating part 10 is mounted onto the fixed part 20 through the fluid dynamic bearing module 30. The rotating part 10 includes a plurality of blades located on the peripheral rim, permanent magnets located on an inner rim in an annular manner and a spindle 101 located in the fluid dynamic bearing module 30 for anchoring in the center of the fixed part 20. The fixed part 20 has a plurality of magnetic poles made from silicon steel sheets wound by coils. When the coils are energized by electric current, the magnetic poles generate magnetic forces to repulse the magnets. As a result, the rotating part 10 may output rotational kinetic energy (this is a technique known in the art, thus details are omitted).

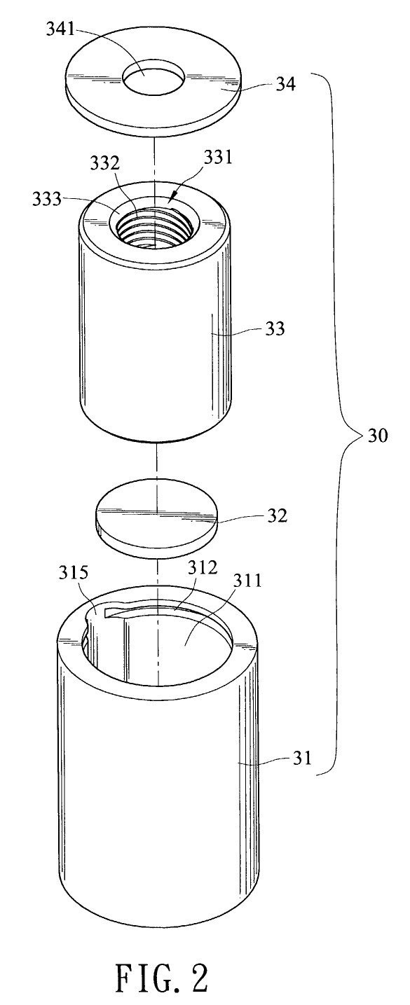

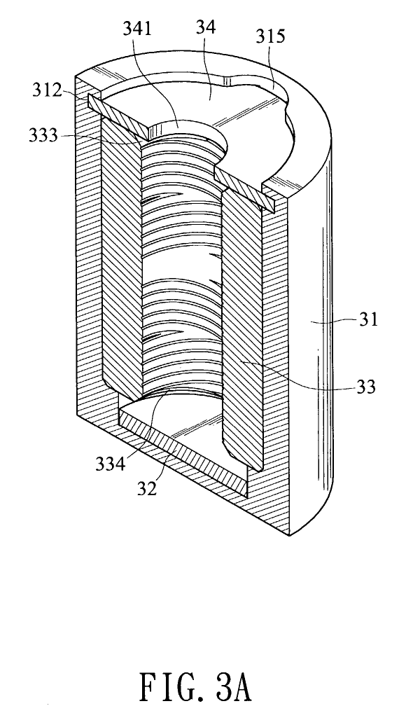

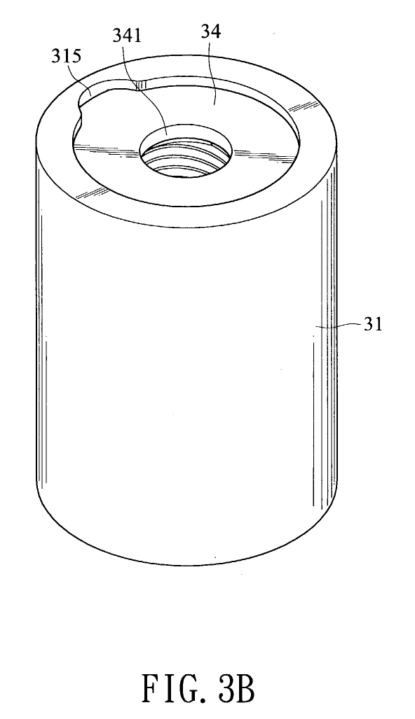

The fluid dynamic bearing module 30 of the invention aims to overcome the disadvantages mentioned above and provide a modular design to facilitate assembly. Referring to FIGS. 2 and 3A, the fluid dynamic bearing module of the invention includes a fluid dynamic bearing 33, a bearing seat 31, a wear-resisting element 32 and an anti-lift element 34. The fluid dynamic bearing 33 is hollow and has a hollow portion 331 in the center to house the spindle 101 of the rotating part 10. The hollow portion 331 has an inner wall with a plurality of dynamic grooves 332 formed thereon to contain a lubricant. When the spindle 101 rotates relative to the fluid dynamic bearing 33, the lubricant generates dynamic pressure in the dynamic grooves 332 to support and lubricate. The bearing seat 31 has a housing chamber 311 with only one opening on one side to house the fluid dynamic bearing 33. The housing chamber 311 has a bottom section with a wear-resistant element 32 located therein to contact the spindle 101 installed in the fluid dynamic bearing 33. The anti-lift element 34 is located on the opening end of the bearing seat 31 (as shown in FIG. 3A) and has a round opening 341 with a radius slightly smaller than the spindle 101 to latch on the spindle 101 and prevent the spindle 101 from escaping.

As the housing chamber 311 of the bearing seat 31 has only one opening and is formed in a cup shape, it cannot leak the lubricant (lubricant) (referring to FIGS. 2 and 3A). The wear-resistant element 32 located at the bottom section of the bearing seat 31 is made from a wear-resistant material, thus it prevents the bottom section of the bearing seat 31 from wearing out. In addition, the wear-resistant element 32 may be made from materials that have elasticity or magnetism to absorb the axial pressure occurring to the spindle 101.

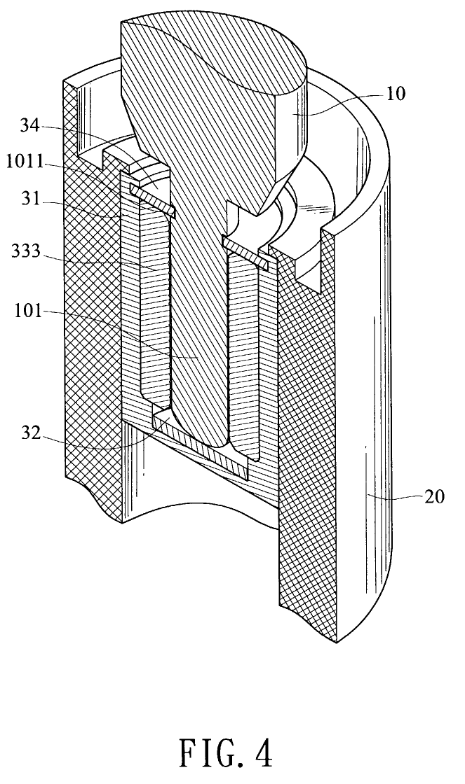

Referring to FIG. 4, the anti-lift element 34 is located in a groove 312 formed on the top end of the bearing seat 31. The round opening 341 in the center is wedged in a latch groove 1011 formed on the spindle 101 for anchoring the spindle 101, thereby providing the lift-proof function for the spindle 101 (or the so-called rotating section 10). The anti-lift element 34, besides being an annular member as shown in the drawings, may also be other sorts of latch rings. Furthermore, the housing chamber 311 of the bearing seat 31 has an air vent trough 315 formed on one side and extended to the bottom thereof to balance the lubricant and air. The design to prevent leaking of the lubricant adopts a chamfered angle. At least one end of the hollow portion 331 has a chamfered angle directing outwards. In the embodiment shown in the drawings, two ends of the hollow section have respectively an upper chamfered angle 333 and a lower chamfered angle 334 to temporarily store the lubricant so that it may be drawn into the gap between the spindle and the bearing while the dynamic grooves 332 are in operation.

By means of such a design, coupling with an air vent trough and a chamfered angle formed on the fluid dynamic bearing, the functions of lubricant leak prevention, spindle lift prevention, balance of the lubricant and air, and spindle wear-resistance can be achieved. Compared with conventional designs, the invention has the following benefits:

a. Integrated design of the cooling fan and the fluid dynamic bearing:

1. The modularized design of the fluid dynamic bearing module increases the convenience of fan assembly, the stability of quality, and reduces product cost.

2. The invention can increase the service life of the fluid dynamic bearing, it reduces noise, and is vibration-resistant.

b. Other features:

1. The fluid dynamic bearing module is a cup-shaped structure, and is thus leak-proof for the lubricant.

2. The anti-lift element is located in the bearing seat to provide a lift-proof function for the spindle.

3. The bearing seat has an air vent trough to balance the lubricant and air.

4. The cup-shaped structure has a thrust-resisting plate to provide wear-resistance for the spindle.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. A fluid dynamic bearing module installed in a fix part to house a spindle of a rotating part in a rotary manner, comprising:
a hollow fluid dynamic bearing for housing the spindle of the rotating part having an inner wall with a plurality of dynamic grooves formed thereon to contain a lubricant such that when the spindle rotates relative to the fluid dynamic bearing the lubricant generates a dynamic pressure in the dynamic grooves to provide support and lubricating effects;
a bearing seat having a housing chamber which has an opening on one side to house the fluid dynamic bearing;
a wear-resisting element located on a bottom section of the housing chamber of the bearing seat and made from a wear-resisting material to contact the spindle installed in the fluid dynamic bearing; and
an anti-lift element located on the opening end of the bearing seat having a round opening which has a radius slightly smaller than the spindle to latch on the spindle to prevent the spindle from escaping.

2. The fluid dynamic bearing module of claim 1, wherein the dynamic grooves are two pairs of herringbone grooves.

3. The fluid dynamic bearing module of claim 1, wherein the housing chamber of the bearing seat has a shape mating the fluid dynamic bearing.

4. The fluid dynamic bearing module of claim 3, wherein the housing chamber of the bearing seat further has an air vent trough.

5. The fluid dynamic bearing module of claim 4, wherein the air vent trough extends to the bottom section of the housing chamber.

6. The fluid dynamic bearing module of claim 1, wherein the housing chamber of the bearing seat has a top end which has a groove for holding the anti-lift element.

7. The fluid dynamic bearing module of claim 1, wherein the spindle has a latch groove corresponding to where the anti-lift element is located for latching the anti-lift element.

8. The fluid dynamic bearing module of claim 1, wherein the hollow portion of the fluid dynamic bearing has at least one end which has a chamfered angle directing outwards.

9. The fluid dynamic bearing module of claim 1, wherein the anti-lift element has a desired elasticity or magnetism to absorb the axial pressure occurred to the spindle to generate a stable operation.

10. The fluid dynamic bearing module of claim 1, wherein the anti-lift element is selectively an annular element or a latch ring.
